(19) United States
(12) Patent Application Publication
(10) Pub. No.: US 2026/0208396 A1
(43) Pub. Date: Jul. 23, 2026

(54) METHOD, DEVICE AND COMPUTER PROGRAM FOR MANUFACTURING ELEMENTS FROM CHIPS OF RECYCLED ELEMENTS

(71) Applicant: FAIRMAT, PARIS (FR)

(72) Inventors: Benjamin SAADA, Paris (FR); Romain PLANCHE, Paris (FR)

(21) Appl. No.: 19/142,579

(22) PCT Filed: Dec. 6, 2023
(86) PCT No.: PCT/FR2023/051943

§ 371 Date: Jun. 23, 2025

(30) Foreign Application Priority Data
Dec. 22, 2022 (FR) FR2214330

(51) Int. Cl. B29B 17/00; B29C 70/06; B29C 70/54; B29K 105/26

(52) U.S. Cl. CPC B29B 17/0042; B29C 70/06; B29C 70/54; B29K 2105/26

(57) ABSTRACT

The invention relates in particular to a method for manufacturing an element made of composite material from chips of at least one first recycled element, said chips being grouped into families according to chip types. After obtaining (125) a plurality of desired characteristics of said element made of composite material and after obtaining, from the desired characteristics and using a knowledge base (135) comprising a set of composition rules, each composition rule associating characteristics of a sample formed of chips of at least one second recycled element with at least one chip type forming said sample and an arrangement of the chips forming said sample, at least one composition rule of said set, at least one chip type and a chip arrangement to be used for manufacturing said element made of composite material are estimated (130) using said at least one obtained rule.

The present invention relates to the field of recycling composite materials, in particular composite materials comprising carbon fibres. In particular, it relates to a method, a device and a computer program for manufacturing an element made of composite material from chips of recycled elements.

Carbon-fibre composite materials are used in many technical fields for their mechanical properties, in particular for their strength and lightness, e.g. in the aviation industry, in the automotive industry, in the nautical industry, but also in the construction and energy industries, etc.

Carbon fibre composite materials generally comprise carbon fibres embedded in a matrix.

Several methods can be used to manufacture carbon fibres, the principle being a deposition of carbon at very high temperature, either derived from paper or viscose (“ex-cellulose” fibres), from polyacrylonitrile (“ex-PAN” fibres), or from residues of petroleum or coal (“ex-pitch” fibre).

The carbon fibres are embedded in the matrix according to a given orientation, for example unidirectionally, or in the form of woven fibre webs.

The matrix typically consists of a polymer or substantially comprises a polymer. The matrix can also be called an “adhesive”, or “resin” (the matrix typically being a polymer). In a well-known manner, the matrix can be thermoplastic or thermosetting.

Thermosetting polymers undergo a chemical reaction (crosslinking) during the shaping of the composite material, which generates chemical bonds and is irreversible. The most effective thermosetting polymers for forming a carbon fibre composite material are polyepoxides (known as “epoxy”).

Thermoplastic polymers are polymers that, above a certain temperature, referred to as the “phase transition temperature”, which is below their thermal degradation temperature, become viscous and can thus be shaped. When the temperature drops below this phase transition temperature, the polymer hardens and returns to its original stiffness. The transition from the viscous state to the solid state is reversible.

The most common thermoplastic polymers are polyethylene (PE), polyethylene terephthalate (PET) or polycaprolactam (PA-6). For some applications, special thermoplastic polymers can be used, such as polyether ether ketone (PEEK), polyphenylene sulphide (PPS), or polyetherimide (PEI).

As the applications of carbon fibre composite materials are numerous and increasingly widespread, the question of how to recycle these materials is posed. Recycling can involve end-of-life or damaged composite material elements, elements manufactured but not meeting or no longer meeting certain standards required for the use for which they are intended, or, more rarely, elements not used by a certain date.

To recycle carbon fibre reinforced composite materials, three main method categories have been developed: so-called mechanical recycling, so-called chemical recycling and so-called thermal recycling.

Mechanical recycling consists, in principle, of breaking up and grinding existing composite material parts to at least partially separate the fibres from the resin, so as to obtain fibres of varying length that can be reused as a reinforcement in the new resin. The low-fibre particles from grinding, which are in powder form, can be mixed with a resin when forming a new composite material element.

The ground composite parts are used as fillers or as a reinforcement in castings, but are not actually intended to replace virgin carbon fibres as used in conventional composite element manufacturing methods (based on non-recycled materials). It is widely accepted that the mechanical properties (flexural strength or flexural stiffness) of a part obtained by a prior art mechanical recycling method are reduced by at least a factor of four compared to those of a similar but new part.

Chemical recycling involves chemically degrading the cured resin of a composite material with the aim of recovering carbon fibres present in this material. The recovered fibres are then typically aligned and/or spun to create a yarn from several thousand recovered fibres. The mechanical properties of parts formed from composite materials comprising these recycled fibres are significantly lower than those of composite materials comprising virgin, unrecycled carbon fibres.

Finally, the principle of thermal recycling involves thermally degrading the resin of a composite material to recover carbon fibres. Heat can be provided by a pyrolysis method, which consists of burning the resin in an oven, by a fluidised bed method that uses the combined action of a solvent and high temperature, and finally by microwaves.

Although these methods are being optimised, the recovered fibres have highly degraded mechanical properties compared to new fibres. The recovered fibres are generally short and they need to be aligned and spun to be reused in applications requiring satisfactory mechanical properties. Failing this, they are used for filling, as are for example the powders obtained in the mechanical recycling methods mentioned above.

The present invention aims to provide a method, a device and a computer program for improving the manufacture of a composite material part from chips of recycled elements at a controlled economic and environmental cost, the composite material part having high mechanical properties.

### DESCRIPTION OF THE INVENTION

The invention relates to the manufacture of a part made of a composite material comprising chips of different types at least in part embedded in a matrix, arranged so as to obtain predetermined technical characteristics. Each chip has a substantially constant thickness defined between two parallel opposite faces of the chip, each chip comprising carbon fibres at least partially embedded in a cured adhesive during a first cure prior to the formation of said part. At least a majority of the fibres of the chip extend substantially parallel to the opposite faces of the chip. The matrix in which each chip is at least partially embedded is formed from an adhesive cured during a second cure. Thus, a bonding interface is formed between the matrix and each chip of the part.

A first aspect of the invention relates to a method for manufacturing an element made of composite material from chips of at least one first recycled element, said chips being grouped into families according to chip types, the method comprising,
obtaining a plurality of desired characteristics of said composite material element,
obtaining, from the desired characteristics, and using a knowledge base comprising a set of composition rules, whereby each composition rule associates characteristics of a sample formed of chips of at least one second recycled element with at least one chip type of the chips forming said sample and an arrangement of the chips forming said sample, at least one composition rule of said set, and
estimating, using said at least one rule obtained, at least one chip type and a chip arrangement to be used to manufacture said composite material element, said elements being synthetic fibre elements.

Thus, from desired characteristics of an element to be manufactured, it is possible to obtain a composition of chips having different characteristics and an arrangement thereof that allows the desired characteristics to be achieved or approached.

According to a particular embodiment, the desired characteristics comprise at least a flexural modulus, a flexural strength, a tensile modulus, a tensile strength, an interlaminar shear strength, a yield strength, light polarisation properties, heat dissipation properties, acoustic properties and/or an electromagnetic wave behaviour.

Still according to a particular embodiment, the chip types are determined according to parameters comprising at least a weave type, a linear or surface density, a mass of the chip, a thickness, a shape, a roughness, a porosity, a surface chemistry, heat dissipation characteristics, electromagnetic properties and/or light polarisation properties.

Still according to a particular embodiment, estimating at least one chip type comprises determining a ratio of chips from different families of chips.

Still according to a particular embodiment, the method further comprises obtaining a plurality of composition rules, the estimation comprising extrapolation or interpolation from the composition rules obtained.

Still according to a particular embodiment, the synthetic fibres comprise carbon fibres and/or para-aramid synthetic fibres.

A second aspect of the invention relates to a method for constructing a knowledge base for manufacturing an element made of composite material from chips of at least one first recycled element, the method comprising,
obtaining a plurality of parameters characterising each of the chips of at least one second recycled element,
determining chip families according to said plurality of parameters,
estimating characteristics of a sample comprising chips of said at least one second recycled element,
determining at least one composition rule associating the estimated characteristics with at least one type of the chips comprised in said sample and an arrangement of the chips comprised in said sample, a chip type corresponding to a family of chips, and
storing said at least one determined composition rule in said knowledge base.

The method according to the invention thus makes it possible to establish rules enabling composite material elements having particular characteristics to be manufactured from recycled elements, for example according to the manufacturing method described above.

According to a particular embodiment, the characteristics of said sample comprise at least a flexural modulus, a flexural strength, a tensile modulus, a tensile strength, an interlaminar shear strength, a yield strength, light polarisation properties, heat dissipation properties, acoustic properties and/or an electromagnetic wave behaviour.

Still according to a particular embodiment, the chip types are determined according to parameters comprising at least one weave type, a linear or surface density, a mass of the chip, a thickness, a shape, a roughness, a porosity, a surface chemistry, and/or heat dissipation characteristics, electromagnetic properties, and/or light polarisation properties.

Still according to a particular embodiment, the composition rule associates the characteristics with a ratio of chip types forming said sample and an arrangement of the chips forming said sample.

Still according to a particular embodiment, said estimation of characteristics of a sample comprises a simulation of said sample.

Still according to a particular embodiment, said estimation of characteristics of a sample comprises manufacturing said sample and carrying out at least one measurement (435) of said manufactured sample. Said sample can be a composite material element manufactured according to the manufacturing method described above.

Still according to a particular embodiment, the method further comprises repeating, for different samples, steps of estimating characteristics, of determining at least one composition rule and of storing said at least one rule in memory.

Still according to a particular embodiment, the method further comprises repeating, for different samples, the step of estimating characteristics, and which comprises a modification of at least one composition rule previously stored in memory.

A third aspect of the invention relates to a device configured to implement the methods described above. The advantages provided by this device are similar to those described previously with regard to the methods.

A computer program, implementing all or part of the method described above, installed on pre-existing equipment, is in itself advantageous, insofar as it allows for easy and quick access to and selection of an event likely to interest a user.

Thus, the present invention further relates to a computer program comprising instructions for implementing the method described above, when this program is executed by a processor.

This program can use any programming language (for example, an object-oriented language or other language), and can be in the form of an interpretable source code, a partially compiled code or a fully compiled code.

Another aspect relates to a non-transitory storage medium of a computer executable program, comprising a dataset representing one or more programs, said one or more programs comprising instructions for, during the execution of said one or more programs by a computer comprising a processing unit optionally coupled to memory means and to an input/output interface module, executing all or part of the method described hereinabove.

### BRIEF DESCRIPTION OF THE DRAWINGS

Other features, details and advantages of the invention will become apparent upon reading the detailed description hereinafter. This description is purely illustrative and must be read with reference to the accompanying drawings wherein:

FIG. 1 diagrammatically illustrates an example of steps of a method for manufacturing an element made of composite material from chips of recycled elements, according to embodiments of the invention;

FIG. 2 diagrammatically illustrates an example of steps for the preparation of chips of recycled elements, according to embodiments of the invention;

FIG. 3 illustrates example arrangements of chips having different characteristics, in particular different sizes;

FIG. 4 illustrates an example of steps for constructing and updating a rule base for defining manufacturing parameters, for example chip types and their arrangement, from characteristics of an element to be manufactured; and

FIG. 5 illustrates an example device that can be used to implement, at least partially, embodiments of the invention, in particular steps described with reference to FIGS. 1, 2 and 4.

### DETAILED DESCRIPTION

In general, the invention relates to the manufacture of a part made of composite material comprising different chip types at least partially embedded in a matrix, arranged in a particular manner during the manufacture of the part such that the chip types and their arrangement make it possible to obtain the characteristics desired for the part, in particular specific mechanical characteristics.

According to some embodiments, each chip has a substantially constant thickness defined between two parallel opposite faces of the chip, each chip comprising carbon fibres at least partially embedded in a cured adhesive during a first cure prior to the formation of said part. At least a majority of the fibres of the chip extend substantially parallel to the opposite faces of the chip. The matrix in which each chip is at least partially embedded can be formed by a thermosetting adhesive crosslinked during a second cure, or by a cured thermoplastic adhesive. In this case, a connection interface is formed between the matrix and each chip of the part. Alternatively, if each chip comprises carbon fibres at least partially embedded in a cured thermoplastic adhesive during a first cure prior to the formation of said part, no adhesive is added and the matrix is formed by the thermoplastic adhesive of each chip of the part.

The bonding interface can substantially comprise mechanical adhesion bonds (mechanical anchoring such as a physical anchoring of the adhesive in the irregularities of the solid surface of the chips), as well as optionally a diffusion bond (diffusion of the adhesive in the chip) and/or a thermodynamic bond, in particular of the “Van der Waals” type.

Throughout this document, the term “substantially” refers conventionally to the perception of this characteristic depending on the system used for its measurement or manufacture. If a characteristic is observed with the naked eye, the term “substantially” therefore refers to the perception that an observer has of this characteristic. An expression containing the term “substantially” shall be interpreted as a technical characteristic produced within the tolerance margin of its manufacturing method. In particular, the character “substantially parallel” between two elements can be understood to mean to the nearest 10° angle. If the considered fibre is embedded in a fabric (typically taffeta, twill or satin), the direction of extension of the fibre is considered by ignoring the ripples of the fibre related to the weave.

With regard to the term “chips at least partially embedded in a matrix”, it is specified that each chip is embedded in the matrix, with the possible exception of certain chips that may emerge from the surface of the part. Similarly, with regard to the term “carbon fibres at least partially embedded in a cured adhesive during a first cure”, it is specified that the carbon fibres are embedded in the adhesive of a chip, with the possible exception of certain fibres which may emerge from the surface of the chip.

Adhesives suitable for the composite materials can be chosen from the group consisting of thermosetting resins such as epoxy resins, ester cyanate and phenolic resins. Suitable epoxy resins include bisphenol A diglycidyl ethers, bisphenol F diglycidyl ethers, novolak epoxy resins and N-glycidyl ethers, glycidyl esters, aliphatic and cycloaliphatic glycidyl ethers, aminophenol glycidyl ethers, glycidyl ethers of any substituted phenols, and mixtures thereof. Also included are modified mixtures of the aforementioned thermosetting polymers. A “modified mixture” refers to a polymer that has been modified, typically by the addition of rubber or thermoplastic.

Any suitable catalyst (or “curing agent”) can be used. The catalyst will be chosen to match the resin used. The catalyst can be accelerated. For example, when a dicyandiamide catalyst is used, a substituted urea can be used as an accelerator.

The curing agent with an epoxy resin can also be chosen from among Dapsone (DDS), Diaminodiphenylmethane (DDM), BF3-amine complex, substituted imidazoles, accelerated anhydrides, meta-phenylenediamine, diaminodiphenyl ether, aromatic polyetheramines, aliphatic amine additive products, aliphatic amine salts, aromatic amine, additive products and aromatic amine salts.

Suitable accelerators comprise Diuron, Monuron, Fenuron, Chlortoluron, toluenediisocyanate bis-urea and other substituted counterparts.

Adhesives suitable for the composite materials can also be chosen from among the group consisting of thermoplastic resins. Thermoplastics are divided into high-performance plastics, technical plastics and standard plastics. Most thermoplastics used in composite materials are high-performance plastics or technical plastics. These plastics differ from standard plastics in particular by their higher wear resistance and chemical resistance. However, standard thermoplastics can have advantages, such as polypropylene combined with glass fibres (GF/PP) or SrPP and SrPET (Self-Reinforced Polypropylene and Self-Reinforced Polyethylene terephthalate), because their glass transition temperature is not very high.

Thermoplastics, depending on their nature, can be hard in amorphous form or in crystalline form. Among the amorphous thermoplastics commonly used in composite materials are polyetherimides (PEI), polyethersulphone (PES), polysulphones (PSU), polycarbonates (PC) and polycarbonate/acrylonitrile butadiene styrene (PC/ABS). Commonly used crystalline thermoplastics in composite materials include polyamides (PA), polyethylene (PE), polyethylene terephthalate, polyphthalamide (PPA), polyphenylene sulphide (PPS), and polyether ether ketone (PEEK).

Each chip is formed such that the orientation of the majority of the fibres it contains is parallel to the faces of the chip. Thus, the fibres can have a significant length and a controlled orientation in the chip. Ultimately, the length and orientation of the fibres in the chips, and the arrangement of the chips in the part, give it high mechanical properties.

The chips can in particular be obtained by cutting up carbon fibre-based composite material elements to be recycled, as explained in more detail hereinafter. The formation of a part according to the invention therefore allows such elements to be recycled, according to a low-polluting mechanical method, while offering good mechanical performances to the formed part.

The faces of each chip can have a surface area, referred to as the chip surface area, of at least 10 mm². These example values are minimum values. Depending on the parts considered, the chips can have a much larger surface area, for example in the order of 3 cm², 5 cm², 10 cm², or 20 cm² or 100 cm².

The chips formed and used here thus have a large surface area, allowing the inclusion of long carbon fibres since the latter extend substantially parallel to the opposite faces of the chip.

Advantageously, each chip has a thickness (e) that is small compared to its other dimensions. Thus, a chip being a substantially two-dimensional, thin part, its other dimensions typically correspond to the largest dimension (d) measurable at the surface of the chip and to the dimension measured perpendicularly, also at the surface of the chip. The ratio (e)/(d) is, for example, between 0.2 and 0.0001 and preferably between 0.06 and 0.0005. It should be noted that unless otherwise stated, the ranges are understood to include the bounds.

In the composite material part, the carbon fibres advantageously extend predominantly in parallel planes. Furthermore, the chips can have a unidirectional arrangement of the carbon fibres, in two different directions, for example a first direction and a second direction forming an angle of 90° to each other, or in multiple directions, it being observed that a controlled orientation of the chips and therefore of the fibres in the part allows the desired mechanical properties to be obtained. Furthermore, the chips can be arranged in the part in a repetitive pattern, corresponding to a particular relative arrangement of a plurality of chips.

The carbon fibres present in each chip can be arranged in webs each having a carbon fibre weave.

In the composite material part, the shape and dimensions of the chips used are chosen to achieve the desired mechanical properties. By way of illustration, each chip can be substantially rectangular in shape (i.e. the faces of each chip are substantially rectangular) with several different sizes.

The thickness of the chips can, for example, be between 100 μm and 1 mm.

The composite material can comprise fibrous areas, formed by the chips and representing between 20% and 85% by volume of the part, and non-fibrous areas, consisting of the adhesive applied and cured during the second cure, forming the remainder of the part. A part made of composite material can comprise:
a plurality of areas comprising carbon fibres and a first adhesive, the carbon fibres having a non-random orientation within a same area, and all of the carbon fibres of said areas being oriented in substantially parallel planes, and
at least one area devoid of carbon fibres, comprising a second adhesive,
   the plurality of areas comprising carbon fibres and a first adhesive being at least partially embedded in the at least one area devoid of carbon fibres comprising a second adhesive, i.e. the second adhesive of the at least one area devoid of carbon fibres encompasses at least 75%, preferably at least 80%, even more preferably at least 85%, such as for example 90%, of the surface of the plurality of areas comprising carbon fibres and the first adhesive.

The areas comprising carbon fibres can also be distributed in a pattern in the composite material part.

The first adhesive can be identical to the second adhesive, the first adhesive having been cured before the second adhesive, or it can be different therefrom.

The part made of composite material can, for example, be a flat or curved panel.

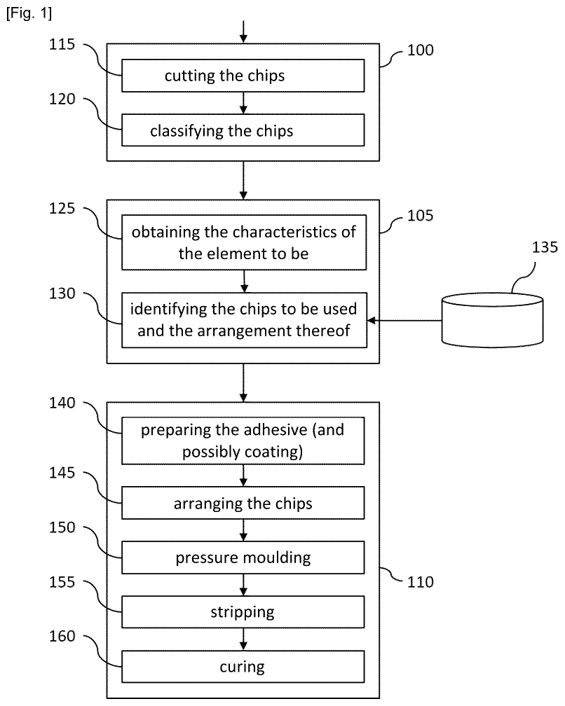

FIG. 1 diagrammatically illustrates an example of steps of a method for manufacturing an element made of composite material from chips of recycled elements according to embodiments of the invention.

As illustrated, the method here comprises three phases: a phase 100 of cutting the elements to be recycled into chips, a manufacture preparation phase 105 in particular to determine the chips to be used and their arrangement, and a manufacturing phase 110.

According to the illustrated example, the phase of preparing the chips to be used for manufacturing an element comprises a step of cutting the elements to be recycled into chips (step 115) and a step of classifying the chips obtained into families (step 120). The elements to be recycled are synthetic fibre elements, for example carbon fibre elements and/or synthetic para-aramide fibre elements such as kevlar fibre elements (kevlar is a trademark). By way of illustration, the examples described mainly relate to carbon fibres.

The chips are obtained by cutting up the elements to be recycled (step 115), for example by mechanical cutting. The chips can be cut using a cutting machine such as a bladed device, for example of the plane type, comprising a blade for separating thin slices of regular thickness from the surface of an element over which it is passed. The material to be cut is positioned in the cutting machine depending on the organisation of the carbon fibres it contains.

If the fibres in the material to be cut are unidirectional, i.e. embedded in a matrix substantially parallel, in only one direction, then the fibres can be positioned parallel to the direction of advancement of the bladed device. If the fibres are embedded in the form of woven webs, the part is preferably positioned such that the weft or warp yarns are substantially parallel to the direction of advancement of the bladed device. The fibres can also be arranged according to a succession of layers, whereby each layer comprises unidirectional fibres, but the layers have different fibre orientations. This is the case, for example, for so-called “quadridirectional” materials, the layers of which can have the following successive relative orientations: 0° (reference layer), 90°, 45°, −45°. The bladed device can then be adjusted such that its blade attacks the element between two layers of fibres, whether it is two layers of unidirectional fibres or two woven webs.

The slices obtained can in particular have a thickness between 200 μm and 1 mm, preferably between 200 μm and 500 μm.

The elements to be recycled can be cut to the desired length for the chips before being cut into slices by the cutting machine, so that the chips with the desired length are obtained directly at the output of the cutting machine.

Alternatively, the slices are then cut again to produce chips. Typically, they are cross-cut by any suitable cutting means, for example by sawing, in order to form thin, rectangular chips of regular length. Of course, other chip shapes can be cut from the resulting slices.

For example, for the production of flat panels, chips of 10 cm to 20 cm in length can be obtained and can produce very good results in terms of mechanical performance. Longer lengths can also be implemented, such as around 50 cm or even 1 m.

Of course, the cutting method described above can be adapted according to the application in question and the quantities to be produced.

When the material to be recycled is a pre-coated but uncured carbon fibre fabric, this material can first be cured (polymerised for a thermosetting resin-coated material) and then cut to the desired shape of the chip. Alternatively, it can be cut to the desired shape of the chip and then cured. Alternatively, it can be cut to the desired shape of the chip without being subsequently cured. Since such a fabric generally has a thickness comprised between 200 μm and 500 μm, the chip thus obtained has a thickness quite suitable for being implemented according to the present invention for forming a part, in particular a casting, made of composite material.

Once formed, the chips therefore take the form of thin elements comprising carbon fibres embedded, at least in part, in a resin. The chips are therefore in the form of substantially two-dimensional parts (in that their thickness is very small compared to their other dimensions). The surface area of the chips is advantageously at least 10 mm², and preferably greater than 3 cm², in the order of 10 cm², or even greater, for example up to about 100 cm².

When the curing of the chip matrix takes place prior to the formation of the final part by casting, this is referred to as a first cure (in order to distinguish it from the curing of the matrix of the part, which aims to bind the chips, and which will be performed during the casting of the part).

The carbon fibres are oriented in the resin of the chips. Preferably, they are substantially parallel, orthogonal to each other, and/or oriented at 45° to each other.

Since the chip fibres have a substantially constant thickness, they comprise two opposite faces (between which the thickness is defined). The chips are cut in such a way that the carbon fibres are kept as intact as possible. For this purpose, the chips are cut such that the fibres (in their majority, or even almost all or all thereof) extend parallel to the opposite faces of the chips. The fibres thus extend in planes parallel to the general plane of extension of the chip, and can have a long length despite the low thickness of the chips.

The term “majority” is understood to mean more than 50% in number and “almost all” is understood to mean more than 90% in number.

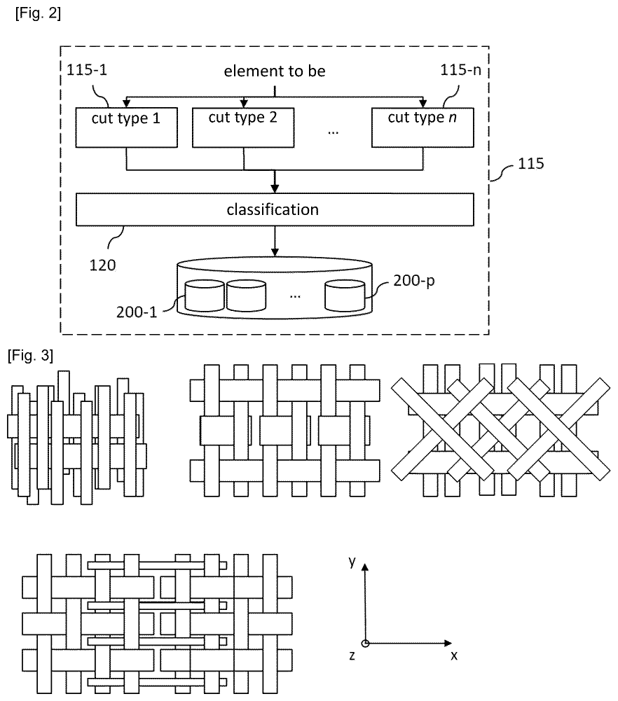

Several cutting machines or several settings of the same cutting machine can be used to cut up parts to be recycled into chips of varying sizes and shapes. Therefore, as illustrated in FIG. 2, several types of cuts can be implemented, for example n types of cuts referenced herein 115-1 to 115-n. Combined with different parts to be recycled and different arrangements of the fibres in these parts, this results in chips having different characteristics in terms of size, in terms of the arrangement of the fibres, etc. and therefore in terms of mechanical characteristics.

In order to improve the use of the chips obtained, the latter are grouped into categories, or families, for example into p families according to the example illustrated in FIG. 2 (given the references 200-1 to 200-p), according to their characteristics, e.g. according to their thickness, dimensions, shape, mass, linear or surface density, fibre orientation (e.g. unidirectional or woven), weave type (e.g., twill weave, plain weave, satin weave, etc.), roughness, porosity, surface chemical properties, heat dissipation characteristics, electromagnetic properties, and light polarisation properties, etc. By way of illustration, the chips can be grouped into the following families:

| Family | Parameters | Values |
|---|---|---|
| 1 | Fibre orientation | Unidirectional |
| | Dimensions | 100 × 10 × [0.3-0.5] mm |
| 2 | Fibre orientation | Woven |
| | Young's modulus | E1 |
| | Thickness | 0.5 mm |
| 3 | Fibre orientation | Woven |
| | Young's modulus | E2 |
| | Thickness | 0.5 mm |
| 4 | Fibre orientation | Woven |
| | Young's modulus | E1 |
| | Thickness | 1 mm |
| 5 | Fibre orientation | Woven |
| | Young's modulus | E2 |
| | Thickness | 1 mm |

where the value of the parameter E1 is greater than that of the parameter E2.

Other parameters can be taken into account. Moreover, the number of families is not necessarily equal to 5. It can be lower or higher than this value.

According to other embodiments, the chips are distributed into families and subfamilies, according to two or more depth levels, the families being linked to one or more first criteria, for example the fibre orientation, the subfamilies being linked to one or more second criteria, for example the chip dimensions, and so on.

With reference again to FIG. 1 and in a subsequent phase (phase 105), the characteristics, for example the mechanical characteristics, of the composite material element to be manufactured from chips of recycled elements are obtained (step 125) and an analysis is performed to identify manufacturing parameters (step 130), for example the chip types to be used and their distribution.

Characteristics of the composite material element to be manufactured (step 125) can be obtained directly from technical specifications of the element, for example a file obtained from an application such as a computer-aided design application and/or can be provided by a user, for example via a graphical interface. They can also be determined from other characteristics of the element to be manufactured. Such characteristics of the element to be manufactured comprise, for example, a flexural modulus, a flexural strength, a tensile modulus, a tensile strength, an interlaminar shear strength, a yield strength, dimensions, light polarisation properties, heat dissipation properties, acoustic properties, and an electromagnetic wave behaviour, etc.

These characteristics are then used to determine manufacturing parameters (step 130). According to particular embodiments, a rule engine or an artificial intelligence engine is used. By way of illustration, a rule engine containing rules associating characteristics of elements to be manufactured from chips with manufacturing parameters such as chip types to be used and their distribution, for example stored in a database 135, can be used to select one or more rules and identify manufacturing parameters, for example by applying the closest rule or by extrapolating from two (or more) closest rules.

Such rules include, for example:

| Rule | Element Characteristics | Manufacturing Parameters |
|---|---|---|
| 1 | mechanical requirement: orthotropic | outer layers with family 1 and material core |
| | material (same longitudinal and transverse | with family 2 |
| | properties) | → 80% family 2/20% family 1 |
| | aesthetic requirement: unidirectional | |
| | appearance on the outside | |
| 2 | mechanical requirement: material stressed | outer layers with family 2, material core with |
| | in a single longitudinal direction | family 1. |
| | aesthetic requirement: woven appearance | → 80% family 1/20% family 2 |
| | on the outside | |
| 3 | dimensional requirement: rolled thickness | two layers with family 5 and one layer with |
| | of 2.5 mm | family 3 (alternatively five layers with family 3, |
| | manufacturing requirement: very short | but shorter manufacturing time with sufficient |
| | manufacturing time (e.g. production in large | mechanical performance levels) |
| | series) | → 66.7% family 5/33.3% family 3 (or → |
| | mechanical requirement: intermediate | 100% family 3) |
| | performance levels | |
| 4 | mechanical requirement: forming a rolled | combination of families 2 and 3 to form a |
| | section with a Young's modulus E3 | rolled section with a modulus E3 following the |
| | manufacturing requirement: need for a lot | law of mixtures: E3 = xE1 + yE2. Combination |
| | of “raw material”, production in large | of two families to expand the material stock |
| | quantities | → x % family 2/y % family 3 |
| 5 | mechanical requirement: high stress on | use of family 4 for the portion with high load |
| | one portion of the part, and medium stress | (modulus E1) and family 5 for the portion with |
| | on the other | medium load (E2) |
| | manufacturing requirement: short | → 50% family 4/50% family 5 |
| | manufacturing time | |

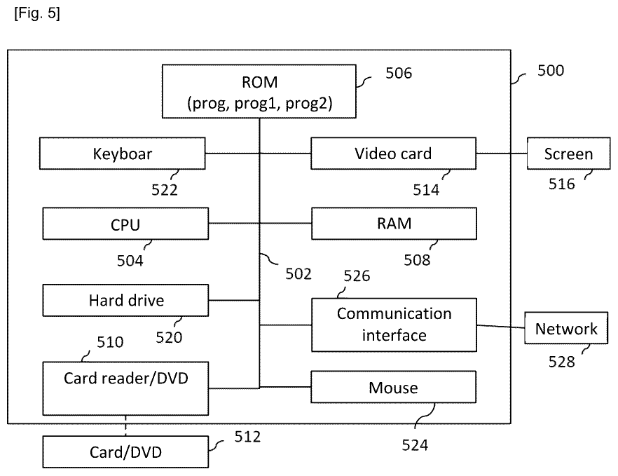

These rules, or some of them, can be defined by specialists and/or users. They can also be populated automatically in the database from measurements or simulation, as described below with reference to FIG. 4.

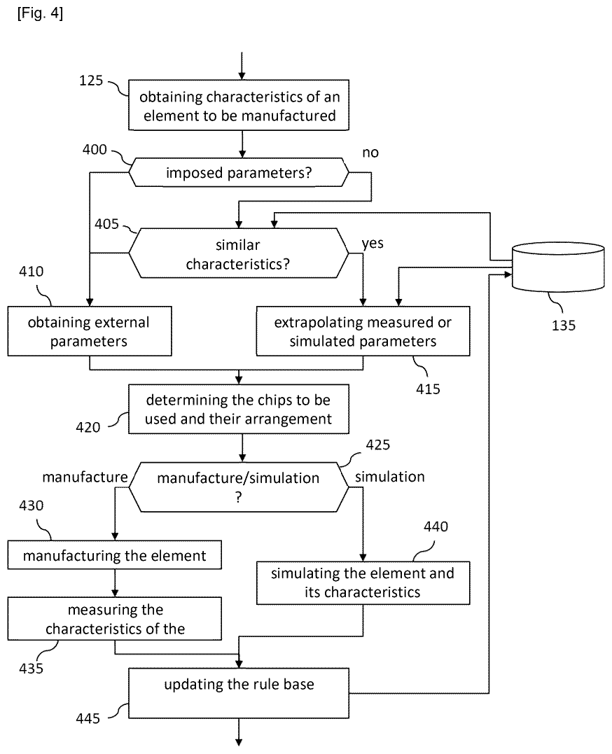

FIG. 3 illustrates example arrangements of chips having different characteristics, in particular different sizes. Of course, many other arrangements are possible and other chip sizes or shapes can be used. It is observed here that the chips can be placed relative to one another precisely or in a random or pseudo-random manner, for example according to given directions and/or densities. Thus, it is possible to provide that all the chips of a same family are placed on a same layer, for example an outer surface of the element to be manufactured, in a same direction (which can be defined with respect to the element to be manufactured or to a direction of other chips), with certain densities in certain regions of the element to be manufactured and other densities in other regions of the element to be manufactured.

With reference again to FIG. 1 and at the end of the manufacture preparation phase 105, the manufacturing phase 110 can begin.

As illustrated, this phase comprises a first step of preparing the adhesive and, optionally, coating (step 140).

In this step, after obtaining the chips corresponding to the manufacturing parameters determined previously, the chips can be mixed with a liquid adhesive in order to coat them, with a view to moulding them (it being observed that the adhesive can be applied differently, for example in the form of a spray, by pouring, etc.). In this case, if chips of several families are used, they are preferably mixed with the liquid adhesive per family so as to be able to be disposed in a mould according to the manufacturing parameters determined, for example in layers.

This step can be carried out before the chips are placed in the mould intended to be used to form the desired part, or during or even after they are placed in the mould. By way of illustration, the description below describes how parts in accordance with embodiments of the invention are obtained on a pilot or prototype scale. In this example, the chips are mixed with an adhesive before being placed in a mould. At the prototype scale, the mixture can be carried out manually in a suitable container, for example made of aluminium. The mixture is preferably powered or mechanised in order to homogenise the adhesive thickness on each chip.

The chips can first be weighed in the container, then the adhesive (e.g. a resin/curing agent system, see below) is prepared and added. Coating is complete when each chip is evenly covered with adhesive. Addition of adhesive and the mixing between chips and adhesive can be done automatically. An automatic mixer can be used to mix the chips and adhesive.

The amount of adhesive to be added to the chips is determined according to the characteristics of the part (e.g. panel) to be produced. The amount of adhesive to be added depends, for example, on the desired volume or mass percentage of chips in the final material, to obtain the desired mechanical properties, and on the adhesive used, in particular its density. The applied masses can also be determined by the panel thicknesses to be obtained.

For many applications where high mechanical performance is desired, the proportion of chips in the material should be maximised. The inventors have produced parts containing up to 80% by weight of chips and believe that parts containing up to 85% by weight of chips, or even slightly more, can be produced successfully.

Various adhesives can be used. In general, all adhesives known to be used as a matrix in composite materials comprising carbon fibres, can be used, with the possible exception of adhesives which would be incompatible with the cured adhesive present in the chips. By incompatible, it is understood that the adhesive used would cause an undesired chemical reaction with the cured adhesive present in the chips or would be poorly suited to form mechanical bonds with the chips. By way of example, two-component epoxy system adhesives can be used. Such two-component epoxy systems comprise an epoxy resin and a curing agent. When the resin and curing agent come into contact, polymerisation begins. The polymerisation time varies depending on the nature of the system used.

A first two-component epoxy system mentioned by way of example is the system marketed by SIKA under the name ADEKIT H9011 (ADEKIT is a registered trademark). The transparency of the adhesive when cured allows the chips to be seen in the final part. A second two-component epoxy system mentioned by way of example is a system marketed by SICOMIN under the name “RÉSINE ÉPOXY SR 1700+DURCISSEUR STANDARD SD 2803”.

As indicated above, many adhesives can be used to form parts in accordance with various embodiments of the invention. In particular, systems intended for composite production applications (infusion, injection, laminating resins), but also systems intended for structural applications as adhesives. In particular, the systems can have a density comprised between 1.03 to 1.38 at 25° C. Their dynamic viscosity can in particular be between 0.4 and 80 Pa·s. They can in particular have a modulus of elasticity (once cured) comprised between 2 GPa and 4 GPa. The polymerisation of these adhesives can be carried out at ambient temperature or at a higher temperature, of the order of 70° C. Since the polymerisation times are substantially different depending on the thermosetting adhesive system, the choice of the system can also depend on this time, depending on the mechanical properties and the desired cycle times.

The one or more additives can also comprise fillers. Fillers refer to all particulate elements that can be added to the adhesive to modify its properties, and/or to lower its cost at equal volume. The envisaged fillers comprise in particular mineral or organic particles likely to improve certain properties of the final part, in particular its resistance to scratching or abrasion.

These fillers are most often mineral in nature (aluminium fillers, calcium fillers, etc.) in the form of nanometric or micrometric particles.

The adhesive can also comprise glass microbeads.

The load used can also comprise carbon dusts, for example from the preparation and cutting operations of the elements to be recycled. In this case, it is therefore an organic load.

Such additives can be provided in the rules used to determine certain manufacturing parameters such as chip types and their positioning.

The mixture of chips and adhesive is then cast.

Alternatively, according to particular embodiments, the chips and the adhesive are deposited in the mould without prior mixing. A first layer of resin is deposited in the mould manually or automatically. A layer of chips is then arranged, in a predefined pattern, manually or automatically. The layers of adhesive and chips are thus alternated until the target thickness is achieved. A first way to deposit the resin into the mould is to use a casting method. The resin and curing agent are contained in two independent tanks, and delivered to a mixing head by pumps. The two products then meet at the end of the mixing head, in a static mixer, to be deposited in the mould in the form of a bead. Another method for depositing the resin in the mould is the spray method. The principle is the same as for the casting method, except in that compressed air is applied through a nozzle at the end of the static mixer in order to atomise the adhesive bead formed in the form of droplets that will be deposited in the mould.

Overmoulding can be performed. For this purpose, at the end of polymerisation, resin is injected into the mould to cover the moulded part and obtain a particular surface condition. The high injection pressure during overmoulding can make it possible to add functional elements to the surface of the moulded part (grooves, notches, rails, etc.) or create the desired surface appearance. Overmoulding can also be carried out on another “insert moulding” type mould. Alternatively or in addition to overmoulding, a gel-coat can be applied to the mould or a top-coat (or finish coat) can be applied to the part once it has been moulded.

By way of illustration, it is considered here that the composite material element to be manufactured is a flat panel. The mould used comprises a concave part, called a female cavity, and a part forming a corresponding male core.

Before inserting the chips, a demoulding agent can be applied to the inner surface of the mould to facilitate the extraction of the part once it has been formed.

When the chips have been mixed with the adhesive, they should be disposed in the female cavity of the mould (step 145), for example according to the manufacturing parameters determined in step 130, and then the press moulding should be finalised (steps 150 and 155).

Depending on the production scale envisaged, the chips can be placed manually, using jigs or visual markers (for example guides formed by a laser), or automatically.

The chips coated with adhesive are arranged in the female cavity of the mould, on an extraction plate. The extraction plate is used to extract the panel from the mould after the pressing action. It can also be used to adapt the thickness of the panel that is formed (several thicknesses can be made in the same mould by varying the thickness of the extraction plate). If an extraction plate is used, it then forms the inner surface of the mould and it is therefore the extraction plate that will be coated with demoulding agent if necessary.

The step of arranging the chips in the mould is important, in particular to allow the manufactured part to have the desired mechanical properties. It must be carried out according to the determined manufacturing parameters.

Assuming that the chips have unidirectional carbon fibres, the chips can be arranged in the mould randomly, unidirectionally (the chips are all arranged in the same direction, with a certain tolerance, for example in the order of more or less 10° or with less than 10% of the chips not respecting the desired orientation and angle tolerance) or multidirectionally (with, where applicable, similar tolerances). FIG. 3 illustrates examples of multidirectional arrangements of the fibres.

A multidirectional arrangement can consist of making several plies (each comprising one or more layers of chips) with different chip orientations between adjacent plies. For example, with rectangular chips, it is possible to alternate the plies, with an arrangement of the chips of one ply at 90° to the chips of the adjacent plies. According to some embodiments, a multidirectional arrangement can therefore be defined as a stack of unidirectional layers as described previously. The example located at the top left of FIG. 3 partially represents three plies (only some chips of each ply are represented to illustrate the stacking of the chips), i.e. an upper ply in which the chips are oriented in a first direction (x), an inner ply in which the chips are oriented in a direction (y) orthogonal to the direction (x) and a lower ply in which the chips are oriented in the first direction (x). The chips of the flat panel taken here as an example are positioned parallel to the plane (x,y). According to other embodiments, the chips are nested into each other, not forming a stack of unidirectional layers, such as in the example located at the bottom left of FIG. 3.

The arrangements presented above relate to a flat panel of low thickness. For the formation of a part having a large thickness (for example a cube) or having a complex three-dimensional shape, it is also possible to position, for moulding, the chips orthogonally to the extension planes of the chips forming a random, unidirectional or multidirectional configuration as described above. These chips, which extend through the thickness of the part, increase the mechanical properties of the part in their direction of extension. Considering an orthogonal reference frame (x,y,z), as shown in FIG. 3, the majority of the chips being oriented in planes parallel to the plane (x,y), with the chips positioned orthogonally, in the z-direction (for example parallel to the plane (x,z) or to the plane (y,z)), thus mechanically reinforce the part in the z-direction.

In general, the arrangement of the chips, as long as it is not purely random, can be such that the chips form a particular pattern that is repeated to form the panel (or more generally a part).

A pattern corresponds to a particular arrangement of several chips together in the three dimensions. Thus, with the exception of a purely random arrangement, the other arrangements envisaged (unidirectional, bidirectional, multidirectional, with where applicable a three-dimensional arrangement of the chips, etc.) can be considered as the repetition of a chip pattern.

The arrangement, geometry, size of the chips used and thickness of the plies can be adapted according to the intended application and thus according to the characteristics of the element to be manufactured. The arrangement, geometry and size of the chips used can also be determined, in particular for an outer ply and at least in part, according to aesthetic criteria. Thus, for example, the arrangement, geometry, and size of the chips of an outer ply can be chosen to form a particular geometric pattern such as a logo.

To some extent, the longer the chips, the better the mechanical properties. However, in practice, the length of the chips that can be formed and used depends on the elements that are recycled and the elements to be manufactured and in particular on their geometric complexity (it is obvious that it is easier to integrate long chips into a large flat panel than into a curved part, with complex geometry, and/or having many geometric details). In general, it is advantageous to use chips whose largest dimension, such as the length, is between 3 and 20 cm.

Once the chips have been disposed in the female cavity of the mould, the mould is closed by positioning the male core. The mould is then installed in a press, which is activated in order to pressurise the mould contents (step 150). Prototypes of panels were produced applying a pressure of between 1 and 50 bar.

When a thermosetting resin is used, polymerisation can take place at ambient temperature. However, the mould can be heated to accelerate polymerisation. To obtain efficient and homogeneous heating (a temperature of around 70° C. can be desired), two heating plates can be used, on either side of the mould. To regulate the heating, and to take into account the exothermic nature of the polymerisation of the adhesive, a closed loop control, for example of the PID type (proportional, integral, derivative) can be used.

A first curing step preferably takes place when the mould is pressed (step 150). Some adhesives, depending on their nature, require a second air curing step (step 160), also known as post-curing.

For the ADEKIT H9011 system, the polymerisation time is 16 h at 70° C. By way of comparison, the complete polymerisation of this adhesive takes around a week at ambient temperature.

The method described above thus makes it possible to manufacture composite material castings formed from composite material elements based on synthetic fibres, for example carbon fibres or para-aramide fibres, to be recycled.

The method described above implements a moulding of the part. Alternatively, other shaping techniques can be used. For example, a pultrusion method or a calendering method can be used.

FIG. 4 illustrates an example of steps for constructing and updating a rule base for defining manufacturing parameters, for example chip types and their arrangement, from characteristics of an element to be manufactured.

As illustrated, the first step here is a step of obtaining characteristics of an element to be manufactured, in particular technical characteristics such as mechanical characteristics, and is for example identical or similar to the step 125 described with reference to FIG. 1.

A test is then performed to determine whether manufacturing parameters are imposed or not (step 400), for example entered by a user, for example via a graphical interface. If manufacturing parameters are not imposed, a test is performed to determine whether the characteristics obtained for the element to be manufactured are close to characteristics of at least one rule stored in the rule base 135 described with reference to FIG. 1. To determine whether the characteristics obtained for the element to be manufactured are close to characteristics of at least one stored rule, the difference can be compared, parameter by parameter, with thresholds, the characteristics obtained for the element to be manufactured being considered as not close to characteristics of at least one stored rule if at least one difference is greater than the corresponding threshold. Alternatively, the differences are accumulated, possibly with a weighting, and compared with a single threshold. Other criteria can be used to estimate the proximity of the characteristics obtained for the element to be manufactured and the characteristics of the rules.

If manufacturing parameters are imposed or if the characteristics obtained for the element to be manufactured are not close to characteristics of at least one stored rule, a next step consists in obtaining the manufacturing parameters (step 410). As described previously, these parameters can be entered by a user, for example through a graphical interface. These parameters comprise, for example, one or more chip types to be used and their arrangement or information for determining these chip types and their arrangement.

If, on the other hand, manufacturing parameters are not imposed and if the characteristics obtained for the element to be manufactured are close to characteristics of at least one stored rule, a next step consists in obtaining manufacturing parameters (step 415), for example from the rule associated with the closest characteristics or by extrapolation from values provided by rules (for example 2 or 3 rules) associated with the closest characteristics.

By way of illustration, if the characteristics of an element to be manufactured comprise a significant resistance to a mechanical stress exerted in a single longitudinal direction and a woven appearance on the outside, it can be determined that these characteristics are close to those referred to in rule 2 of the table provided previously and comprising an example of rules, to which are associated manufacturing parameters indicating chip types to be used and their proportions, in this case 80% with chips of family 1 and 20% with chips of family 2, the chips of family 2 being, for example, placed on the outer layers and the chips of family 1 being, for example, disposed in an inner layer.

After obtaining the manufacturing parameters and if these do not comprise chip types to be used and their arrangement, the one or more chip types to be used and their arrangement are determined from the parameters obtained (step 420).

A test is then performed to determine whether the element to be manufactured should actually be manufactured or if it should be simulated (step 425). This choice can be made automatically, for example depending on the context, or by a user, for example via a graphical interface. When the choice is made automatically, it may nevertheless be necessary for it to be validated by a user. According to some embodiments, an element to be manufactured is manufactured and simulated.

After the element has been manufactured (step 430), if it is to be manufactured, some of its characteristics are measured (step 435), for example its flexural modulus, flexural strength, tensile modulus, tensile strength, interlaminar shear strength, yield strength, or dimensions, etc., to establish a link between these characteristics and the manufacturing parameters of this element.

Similarly, if the element to be manufactured is to be simulated, some of its characteristics are estimated (step 440), typically the same as those measured on a manufactured element, in order, again, to establish a link between these characteristics and the manufacturing parameters of this element.

In a next step (step 445), the rule base, for example the rule base 135, is updated. This step can consist of modifying an existing rule, for example to add one or more parameters or one or more characteristics or to adjust a range of values of one or more parameters or one or more characteristics. This update can also involve adding a rule. These modifications or additions can be made automatically, if necessary after validation by a user. Alternatively, these modifications or additions can be made by a user based on the manufacturing parameters of the element and the measured or simulated features. These parameters and characteristics can be presented to a user via a graphical interface that they can also use to modify a rule that they have chosen or that has been selected automatically, or to add a new rule.

According to other embodiments, the rule engine is replaced or used in addition to an artificial intelligence engine, for example an artificial neural network whose inputs are the characteristics of the element to be manufactured and the outputs are the manufacturing parameters. Such an engine can be driven with measured or simulated characteristics and corresponding manufacturing parameters.

This rule base and/or this artificial intelligence engine constitute a knowledge base that makes it possible to estimate manufacturing parameters for a composite material element based on chips of recycled elements according to characteristics of the element to be manufactured.

FIG. 5 illustrates an example of a device that can be used to implement, at least partially, embodiments of the invention, in particular steps described with reference to FIGS. 1, 2 and 4.

The device 500 is, for example, a server, a computer, a terminal or a personal device such as a smartphone or a tablet.

Preferably, the device 500 comprises a communication bus 502 to which the following are connected:
a central processing unit or microprocessor 504 (CPU);
a read-only memory 506 (ROM) that can contain an operating system and programs such as “Prog”;
a random-access memory or cache memory 508 (RAM) containing registers adapted to save variables and parameters created and modified during the execution of the aforementioned programs; and
a communication interface 526 connected to a distributed communication network 528, for example a wireless communication network and/or a local communication network, the interface being able to transmit and receive data, in particular to and from a device of a user.

Optionally, the device 500 can also have the following elements:
a hard drive 520 that can contain the aforementioned programs “Prog” and data processed or to be processed according to the invention;
a keyboard 522 and a mouse 524 or any other pointing device such as a light pen, a touchscreen or a remote control making it possible for the user to interact with the programs according to the invention;
a reader 510 for reading a removable storage medium 512 such as a memory card or a disc, for example a DVD disc; and
a graphics card 514 connected to a screen 516.

The communication bus makes communication and interoperability between the various elements included in the device 500 or connected thereto possible. The representation of the bus is not restrictive and, in particular, the central processing unit can communicate instructions to any element of the device 500 directly or by means of another element of the device 500.

The executable code of each program making it possible for the programmable device to implement the processes according to the invention can be stored, for example, in the hard drive 520 or in the read-only memory 506.

According to an alternative embodiment, the executable code of the programs can be received by means of the communication network 528, via the interface 526, in order to be stored in a manner identical to that described above.

More generally, the one or more programs can be loaded into one of the storage means of the device 500 before being executed.

The central processing unit 504 will control and direct the execution of the instructions or portions of software code of the one or more programs according to the invention, which instructions are stored in the hard drive 520 or in the read-only memory 506 or in the other aforementioned storage elements. Upon start-up, the one or more programs that are stored in a non-volatile memory, for example on the hard drive 520 or the read-only memory 506, are transferred into the random-access memory 508 which then contains the executable code of the one or more programs according to the invention, as well as registers for storing the variables and parameters necessary to implement the invention.

Depending on the embodiment chosen, certain acts, actions, events or functions of each of the methods described in the present document can be carried out or occur in an order different to that wherein they have been described, or can be added, merged or even not be carried out or not occur, depending on the case. Furthermore, in certain embodiments, certain acts, actions or events are carried out or occur concurrently and not successively.

Although described through a certain number of detailed example embodiments, the method proposed and the equipment for implementing the method comprise various alternative embodiments, modifications and improvements that will become apparent to the person skilled in the art, it being understood that these various alternative embodiments, modifications and improvements fall within the scope of the invention, as defined by the following claims. In particular, although the examples presented are related to synthetic fibre elements to be recycled and manufactured, the invention can be implemented with other types of fibres, in particular natural fibres such as flax fibres and/or mineral fibres such as glass or basalt fibres.

In addition, various aspects and features described hereinabove can be implemented together, or separately, or substitute one another, and all of the various combinations and sub-combinations of the aspects and features fall within the scope of the invention. Furthermore, it is possible that some systems and equipment described hereinabove do not incorporate all of the modules and functions described for the preferred embodiments.

1. A method for manufacturing an element made of composite material from chips of at least one first recycled element, said chips being grouped into families according to chip types, the method comprising,
obtaining a plurality of desired characteristics of said composite material element,
obtaining, from the desired characteristics, and using a knowledge base comprising a set of composition rules, whereby each composition rule associates characteristics of a sample formed of chips of at least one second recycled element with at least one chip type of the chips forming said sample and an arrangement of the chips forming said sample, at least one composition rule of said set, and
estimating, using said at least one rule obtained, at least one chip type and a chip arrangement to be used to manufacture said composite material element,
said elements being synthetic fibre elements.

2. The method according to claim 1, wherein the desired characteristics comprise at least a flexural modulus, a flexural strength, a tensile modulus, a tensile strength, an interlaminar shear strength, a yield strength, light polarisation properties, heat dissipation properties, acoustic properties and/or an electromagnetic wave behaviour.

3. The method according to claim 1, wherein the chip types are determined according to parameters comprising at least a weave type, a linear or surface density, a mass of the chip, a thickness, a shape, a roughness, a porosity, a surface chemistry, heat dissipation characteristics, electromagnetic properties and/or light polarisation properties.

4. The method according to claim 1, wherein estimating at least one chip type comprises determining a ratio of chips from different families of chips.

5. The method according to claim 1, further comprising obtaining a plurality of composition rules, the estimation comprising extrapolation or interpolation from the composition rules obtained.

6. The method according claim 1, wherein the synthetic fibres comprise carbon fibres and/or para-aramid synthetic fibres.

7. A method for constructing a knowledge base for manufacturing an element made of composite material from chips of at least one first recycled element, the method comprising,
obtaining a plurality of parameters characterising each of the chips of at least one second recycled element,
determining chip families according to said plurality of parameters,
estimating characteristics of a sample comprising chips of said at least one second recycled element,
determining at least one composition rule associating the estimated characteristics with at least one type of the chips comprised in said sample and an arrangement of the chips comprised in said sample, a chip type corresponding to a family of chips, and
storing said at least one determined composition rule in said knowledge base.

8. The method according to claim 7, wherein the characteristics of said sample comprise at least a flexural modulus, a flexural strength, a tensile modulus, a tensile strength, an interlaminar shear strength, a yield strength, light polarisation properties, heat dissipation properties, acoustic properties and/or an electromagnetic wave behaviour.

9. The method according to claim 7, wherein the chip types are determined according to parameters comprising at least one weave type, a linear or surface density, a mass of the chip, a thickness, a shape, a roughness, a porosity, a surface chemistry, and/or heat dissipation characteristics, electromagnetic properties, and/or light polarisation properties.

10. The method according to claim 7, wherein the composition rule associates the characteristics with a ratio of chip types forming said sample and an arrangement of the chips forming said sample.

11. The method according to claim 7, wherein said estimation of characteristics of a sample comprises a simulation of said sample.

12. The method according to claim 7, wherein said estimation of characteristics of a sample comprises manufacturing said sample and carrying out at least one measurement of said manufactured sample.

13. The method according to claim 12, wherein said sample is an element made of composite material from chips of at least one first recycled element, said chips being grouped into families according to chip types, the method comprising,
obtaining a plurality of desired characteristics of said composite material element,
obtaining, from the desired characteristics, and using a knowledge base comprising a set of composition rules, whereby each composition rule associates characteristics of a sample formed of chips of at least one second recycled element with at least one chip type of the chips forming said sample and an arrangement of the chips forming said sample, at least one composition rule of said set, and
estimating, using said at least one rule obtained, at least one chip type and a chip arrangement to be used to manufacture said composite material element,
said elements being synthetic fibre elements.

14. The method according to claim 7, the method further comprising repeating, for different samples, steps of estimating characteristics, of determining at least one composition rule and of storing said at least one rule in memory.

15. The method according to claim 7, the method further comprising repeating, for different samples, the step of estimating characteristics, and which comprises a modification of at least one composition rule previously stored in memory.

16. A computer program comprising instructions for implementing each of the steps of the method according to claim 1, when this program is executed by a processor.

17. A device comprising a processing unit configured to execute each of the steps of the method according to claim 1.
